(19) United States
(12) Patent Application Publication
(10) Pub. No.: US 2014/0117636 A1
(43) Pub. Date: May 1, 2014

(54) FRONT WHEEL ASSEMBLY FOR CHILD SUPPORT DEVICE

(71) Applicant: KIDS II, INC., Atlanta, GA (US)

(72) Inventor: David GILBERT, Cumming, GA (US)

(73) Assignee: KIDS II, INC., Atlanta, GA (US)

(21) Appl. No.: 14/066,076

(22) Filed: Oct. 29, 2013

Related U.S. Application Data
(60) Provisional application No. 61/720,702, filed on Oct. 31, 2012.

(51) Int. Cl. B60B 11/02; B62B 7/04

(52) U.S. Cl. CPC B60B 11/02; B62B 7/04
USPC 280/62; 280/80.1; 280/86

(57) ABSTRACT

A front wheel assembly for a child support device including a first castor wheel coupled to first swivel joint and a second castor wheel coupled to a second swivel joint, the first and second swivel joints being operatively coupled together by a linkage that steers the wheels in unison and maintains a generally parallel alignment between the wheels. The wheels are sufficiently spaced apart to allow for 360-degree pivoting of each of the wheels. Also a child support device such as a stroller, including such a front wheel assembly.

### CROSS-REFERENCE TO RELATED APPLICATIONS

This application claims priority benefit to U.S. Provisional Patent Application Ser. No. 61/720,702 filed Oct. 31, 2012, the entirety of which is hereby incorporated by reference herein.

### TECHNICAL FIELD

The present invention relates generally to the field of wheeled transport devices, and more particularly to a wheel assembly for a child support and transport device such as a stroller, carriage or pram.

### BACKGROUND

Various forms of wheeled transport devices for infants and small children are known. For example, three-wheeled and four-wheeled strollers of different designs are commonly used to carry children and accessories. The use of 360-degree pivoting twin-wheeled castors in lieu of fixed-axle wheels on both three- and four-wheeled strollers to enable easier steering is also known. Conventional three-wheeled strollers typically have one front wheel assembly and two spaced-apart rear wheel assemblies. Many three-wheeled strollers often suffer from instability in comparison with a four-wheeled stroller, but many four-wheeled strollers can be less maneuverable and/or less compact than a three-wheeled stroller.

Accordingly, it has been found that needs exist for a wheel assembly for a child transport device providing smooth maneuverability and stability in use. It is to the provision of an improved wheel assembly and to child transport devices having such a wheel assembly, which meet these and other needs that the present invention is primarily directed.

### SUMMARY

In example forms, the present invention relates to an improved wheel assembly, as well as a transport device having such a wheel assembly. Embodiments of the wheel assembly provide a stable and maneuverable front wheel assembly for a stroller, pram, carriage or other transport device for carrying infants, small children, accessories, and/or other items. In an example embodiment, the front wheel assembly comprises at least two wheels linked together such that they maintain a generally parallel orientation with respect to one another at all times. In further examples, each of the wheels of the assembly is pivotally mounted to a frame or support member by an independent pivotal coupling.

In another aspect, the invention relates to a child support device, such as a stroller, pram or carriage. The child support device includes a frame, a child-receiving receptacle or seat, and one or more wheel assemblies that allow the child support device to be rolled across a support surface. The child support device includes a front wheel assembly that comprises at least two wheels linked together such that they maintain a generally parallel orientation with respect to one another at all times. In further examples, each of the wheels of the assembly is pivotally mounted to a frame or support member by an independent pivotal coupling. The two wheels of the front wheel assembly are spaced a first distance apart from one another. Still further example embodiments include two rear wheel assemblies spaced a second distance apart from one another, with the second distance being greater than the first distance.

In another aspect, the invention relates to a wheel assembly for a child support device. The wheel assembly preferably includes a first wheel coupled to a first swivel mechanism, a second wheel coupled to a second swivel mechanism, and a linkage coupling the first swivel to the second swivel and configured to allow the first wheel and second wheel to swivel together in generally synchronized or coupled motion.

In another aspect, the invention relates to a wheel assembly preferably including a first wheel and a second wheel maintained in substantial alignment. The first wheel is preferably coupled to a first swivel mechanism and the second wheel is preferably coupled to a second swivel mechanism. The wheel assembly preferably also includes a first gear coupled to the first swivel mechanism; a second gear coupled to the second swivel mechanism; and one or more additional gears engaged with first gear and second gear to form a gear train, wherein the gear ratio between the first gear and the second gear is approximately equal to one.

In another aspect, the invention relates to a wheel assembly for a transport device, the wheel assembly preferably including a support member and first and second wheels, wherein the first and second wheels are pivotally mounted to the support member by separate pivotal couplings, and operatively coupled to pivot in generally synchronized motion relative to the support member.

In another aspect, the invention relates to a wheeled transport device preferably including first and second rear wheels and a front wheel assembly, wherein the front wheel assembly includes a pair of pivotally mounted front wheels operatively coupled to pivot in generally synchronized motion, each of the front wheels being pivotally mounted to a support member by a separate pivotal coupling.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 shows a perspective view of a front wheel assembly for a transport device, according to an example embodiment of the present invention.

FIG. 2 shows the front wheel assembly of FIG. 1 with a cover portion removed to better show internal components of the mechanism.

FIG. 3 is an assembly view showing the front wheel assembly of FIG. 1 in a disassembled state.

FIG. 4 shows a front view of the front wheel assembly of FIG. 1 with the wheels turned 90 degrees to the right of a straight-forward orientation, and with a cover portion omitted to show internal components of the mechanism.

FIGS. 5A-5B show another example embodiment of a wheel assembly for a transport device.

FIGS. 6A-6B show another example embodiment of a wheel assembly for a transport device.

FIGS. 7A-7B show another example embodiment of a wheel assembly for a transport device.

FIG. 8 shows a transport device and wheel assembly according to an example embodiment.

FIG. 9 shows another example embodiment of a wheel assembly for a transport device, including a belt-and-pulley linkage mechanism.

FIG. 10 shows another example embodiment of a wheel assembly for a transport device, including a sprocket-and-drivechain linkage mechanism.

FIG. 11 is a detailed side view of a castor component of a wheel assembly for a transport device.

FIG. 12 is a detailed front view showing camber of a wheel assembly for a transport device.

FIG. 13 is a detailed front view of a gear-train linkage of a wheel assembly for a transport device showing an example degree of backlash between teeth of adjacent gears.

FIGS. 14A and 14B show a caster locking mechanism for a wheel assembly for a transport device according to an example embodiment, in unlocked and locked configurations, respectively.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

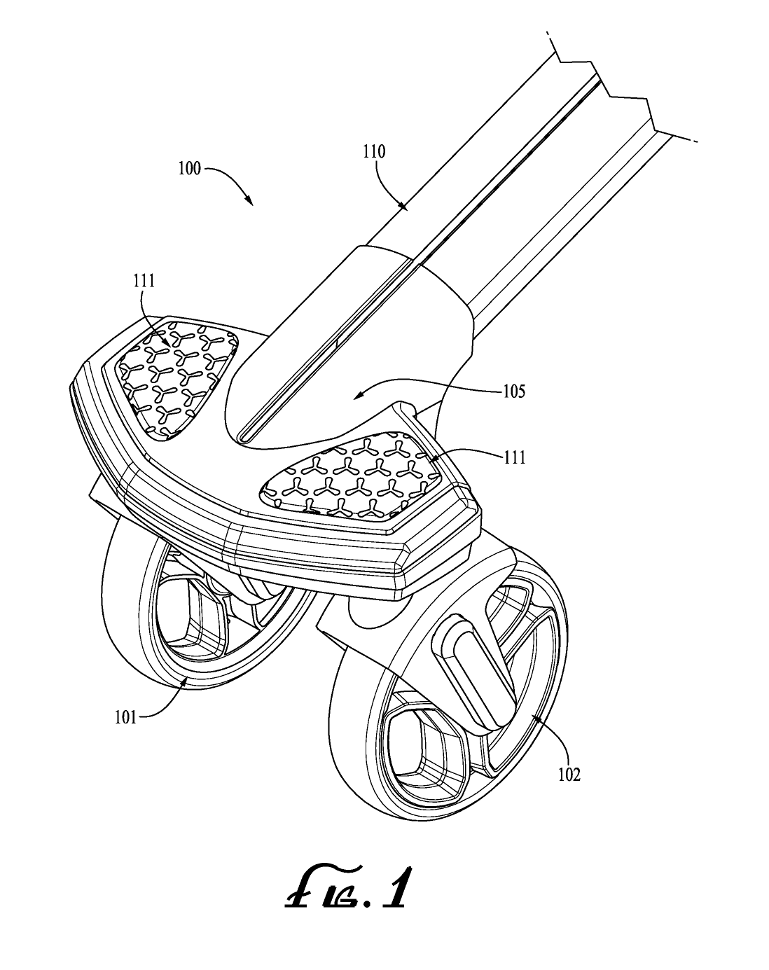

With reference now to the drawing figures, wherein like reference numbers represent corresponding parts throughout the several views, FIG. 1 shows a wheel assembly for a child support device such as, for example, a stroller, pram or carriage. In example applications, the wheel assembly 100 can be mounted to the front leg 110 of a three-wheeled type of stroller (i.e., a stroller having a pair of rear wheels spaced on opposite sides of the stroller seat, and the wheel assembly 100 in place of the single front wheel or castor assembly typically found on a three-wheeled stroller. In alternate embodiments, the wheel assembly 100 can be utilized in place of one or more front or rear wheels of a three-wheeled, four-wheeled, or otherwise configured stroller, pram, carriage or other wheeled transport device.

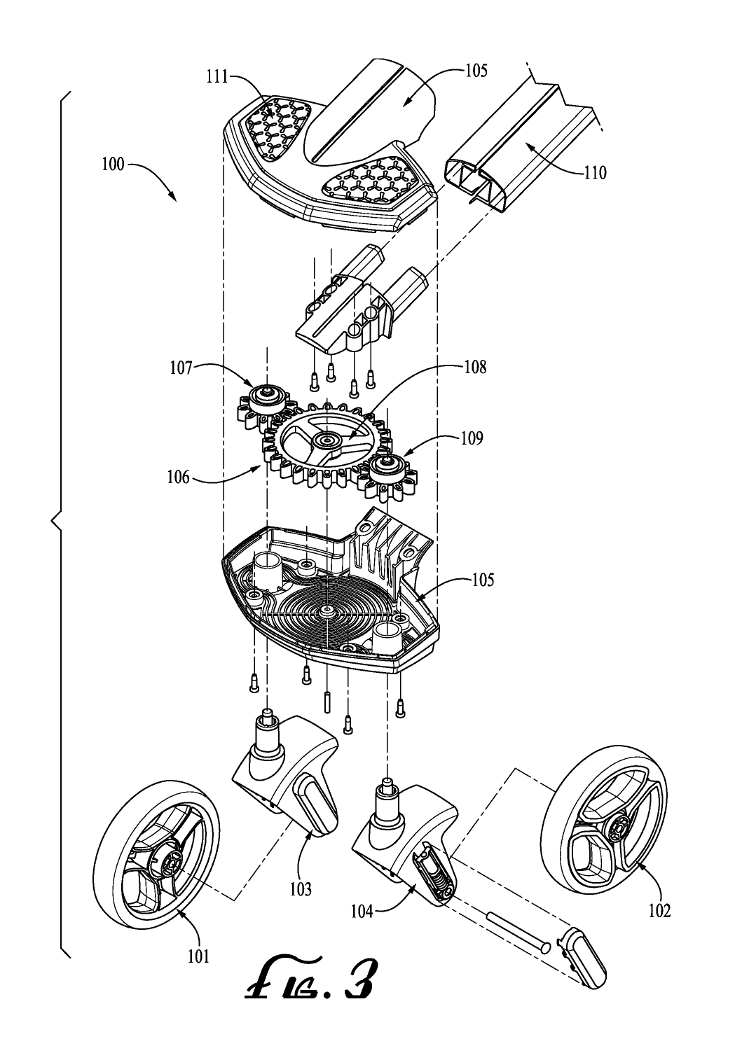

The front wheel assembly 100 includes a first castor wheel assembly 101 and a second castor wheel assembly 102. The first and second castor wheels 101, 102 are preferably of substantially identical size and share a common orientation substantially aligned with one another. The wheels are rotationally mounted to the castor on wheel axles to allow rolling of the wheeled transport device along the ground or other support surface. The first castor wheel assembly 101 is pivotally mounted to a frame member or support housing 105 by a first swivel coupling 103. The second castor wheel 102 is pivotally mounted to the frame member or support housing 105 by a separate second swivel coupling 104, such that the first and second castor wheels are individually and separately pivotally coupled to the frame member or support housing. The first swivel and second swivel 103, 104 are spaced apart such that the first castor wheel 101 and second castor wheel 102 swivel about different, but generally or substantially parallel axes. The axes of the swivel couplings 103 and 104 are preferably separated by a first distance or wheel spacing S₁ at least equal to and preferably greater than the diameter D of the wheels 101 and 102, such that the first and second castor wheels 101, 102 can both rotate a full 360° without interference. Furthermore, there is a gap 114 between the first and second castor wheels 101 and 102 when they are turned completely sideways and generally or substantially aligned with one another, as shown in FIG. 4. Optionally, the castor wheels 101, 102 can be cambered at an angle offset from vertical for improved stability and maneuverability.

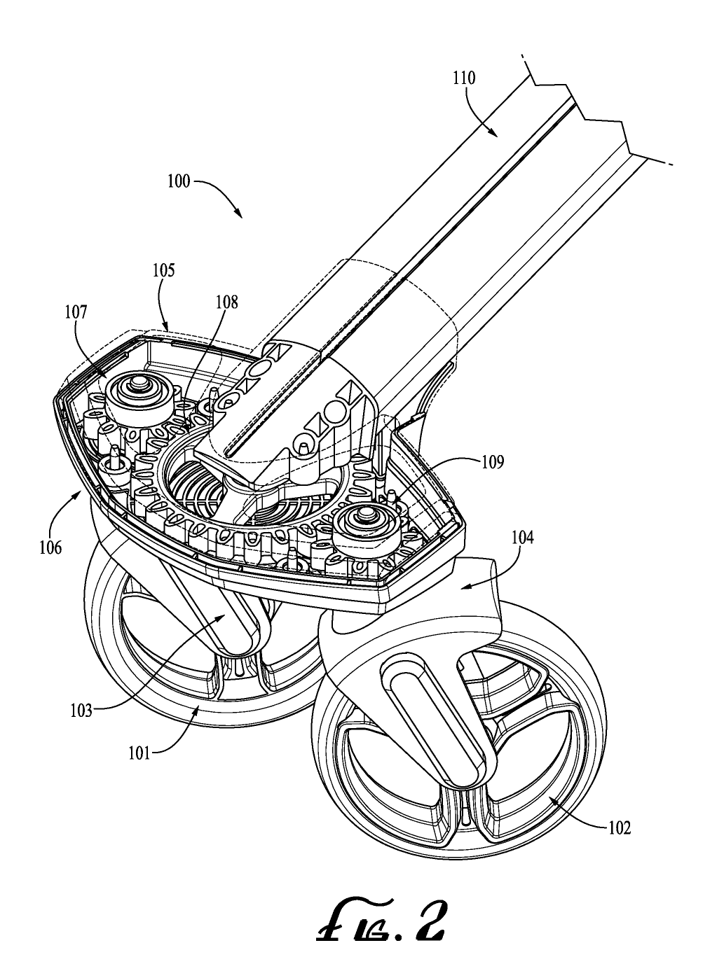

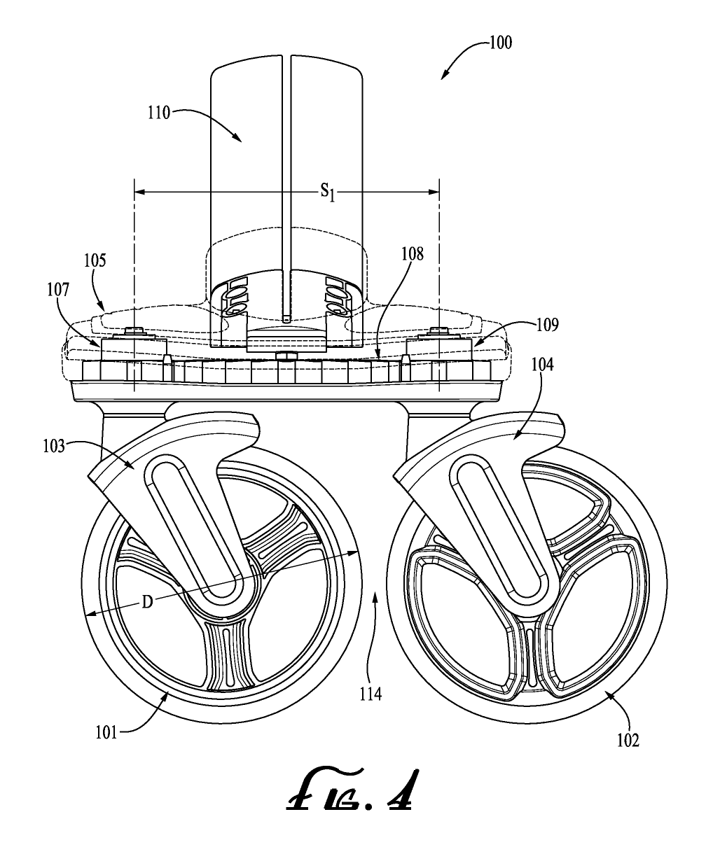

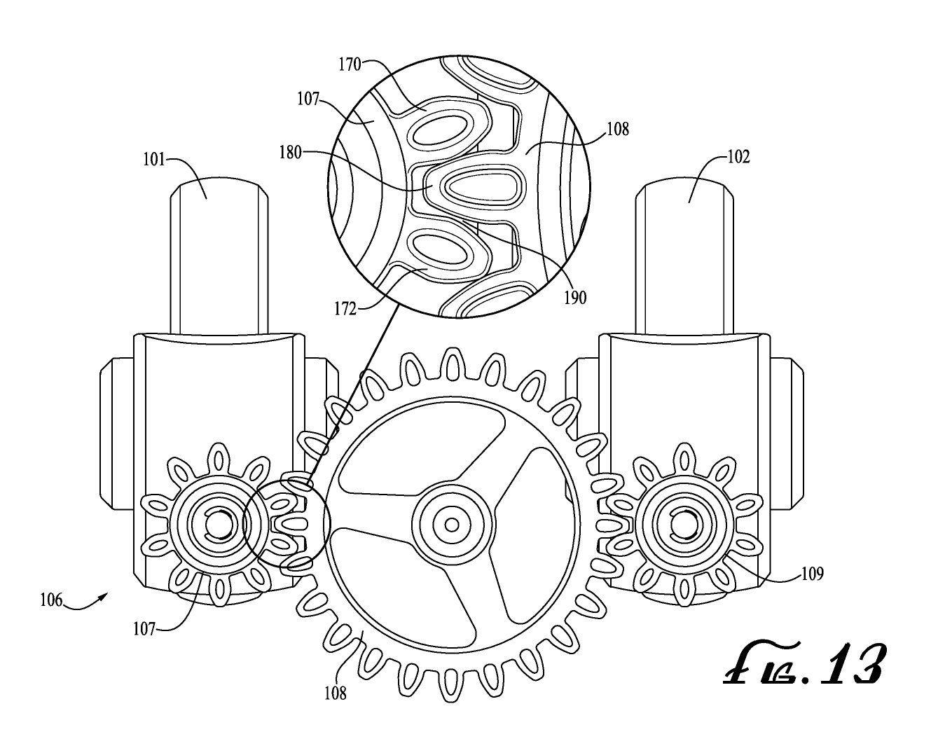

The front wheel assembly 100 preferably includes a linkage such as a gear train 106 configured to link the first swivel 103 to the second swivel 104, such that the first castor wheel 101 and second castor wheel 102 are operatively coupled to swivel in unison with one another and remain generally or substantially parallel to one another as they turn. In the example embodiment depicted in FIGS. 1-4, the gear train 106 comprises a first gear 107 coupled to the first swivel 103, a second, intermediate gear 108 mated with the first gear 107, and a third gear 109 coupled to the second swivel 104 and mated with the second gear 108. In alternate embodiments, one or more additional gears may be incorporated in the gear train. The gear train 106 is configured such that the first and third gears 107 and 109 have the same diameter and pitch, whereby they move with the same angular velocity at all times, and thus a near identical orientation is maintained between the first castor wheel 101 and second castor wheel 102. With reference to FIG. 13, teeth 170 of the first gear 107 engage teeth 180 of the second gear 108 by contact along confronting sides of the respective teeth as wheel 101 turns, and a degree of spacing or backlash 190 is preferably provided between the gear teeth, which is apparent in the drawing figure at the trailing side of gear tooth 180. This spacing or backlash 190 allows sufficient play between the coupled rotation of the wheels 101, 102 so that the wheels may vary slightly from exactly parallel to one another to follow a natural turning radius (the turning radius of the two wheels may differ slightly based on how far the wheel is from the center of the turn), but still maintain a generally or substantially parallel alignment. A similar backlash is preferably provided between teeth of the third gear 109 and the second gear 108, with the combined tolerance at both gear interfaces being, for example, about 10⁰-12⁰ or less. Greater or lesser degrees of backlash may be provided depending on the geometry of a particular embodiment, to resist binding in the linkage as the wheels turn during steering of the transport mechanism. The gear train 106 is enclosed in a protective housing 105 which is coupled to the front leg 110 of the stroller. The housing 105 optionally comprises axial hubs upon which the gears 107, 108, 109 are rotationally mounted. Example embodiments of the housing 105 can include a generally horizontal, planar upper platform with textured areas 111 that can serve as footholds to aid an occupant in stepping into the stroller. The housing 105 optionally also includes a receiver or extension for engagement with the leg 110 or other frame member of the transport device to which the wheel assembly 100 is mounted. FIGS. 5A and 5B show another example embodiment of a wheel assembly 200 for a stroller or other transport mechanism. The wheel assembly 200 includes a first wheel 210 and a second wheel 212, which are independently pivotally mounted to a support housing or frame member 220 of the transport mechanism by separate pivotal couplings 214, 216.

A linkage 230 operatively couples the pivotal rotation or swivel of wheels 210, 212 so that they pivotally rotate together in tandem side-by-side or steer in generally synchronized or coordinated motion and maintain a generally or substantially parallel alignment throughout their range of rotation. FIG. 5A shows the wheels 210, 212 rotated in a first direction, and FIG. 5B shows the wheels rotated in an opposite second direction, as indicated by the directional arrows. The linkage 230 comprises a first crank or yoke 240 extending transversely from a first castor shaft or axle 242 of the first pivotal coupling 214, to which the first wheel 210 is mounted; and a second crank or yoke 244 extending transversely from a second castor shaft or axle 246 of the second pivotal coupling 216, to which the second wheel 212 is mounted. An intermediate link 250 is pivotally connected at its first end to the first yoke 240 and at its second end to the second yoke 244. Optionally, a first rail 252 extends axially through a slot in the intermediate link 250, and a second rail 260 is mounted to the support or frame member 220, the second rail being generally perpendicular to and vertically offset from the first rail; and a slider link 270 is coupled between the first and second rails, with a first sleeve sliding along the first rail and a second sleeve sliding along the second rail. The castor shafts 242, 246 can be mounted rotationally within and supported axially by bearings 280, 282 mounted to the support housing or frame member 220, whereby the first and second crank or yoke members 240, 244 allow the intermediate linkage 250 to pass through the vertical castor axes as the wheels 210, 212 rotate. Alternatively, the upper axial support for the castor shafts can be omitted, and the shafts carried by lower bearings at the base, whereby the first and second crank members 240, 244 extend transversely from the upper ends of the shafts.

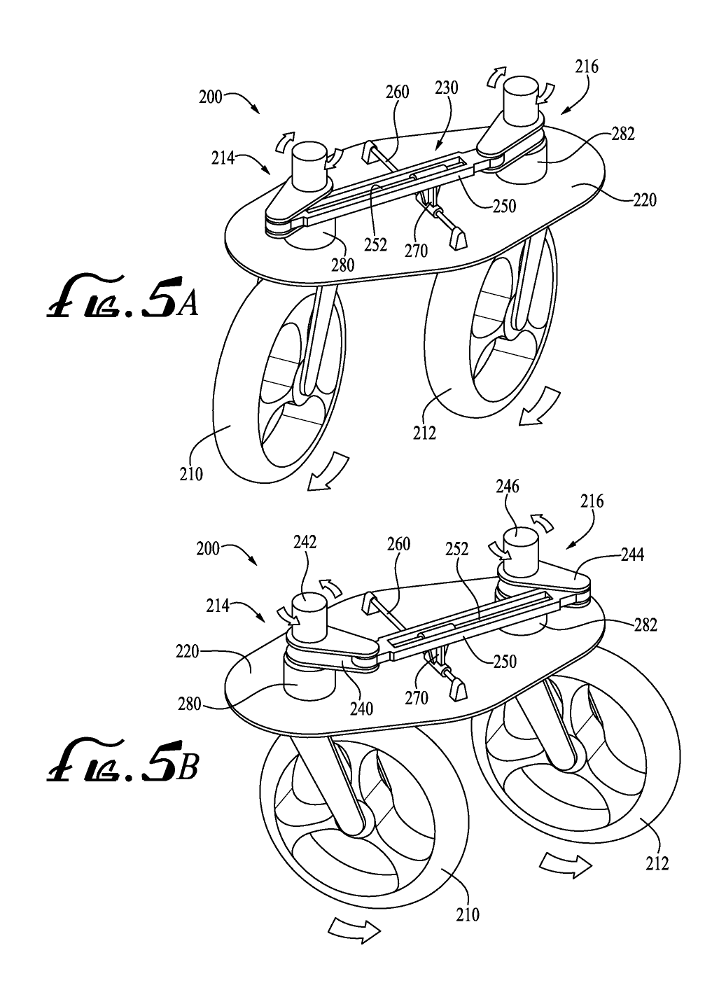

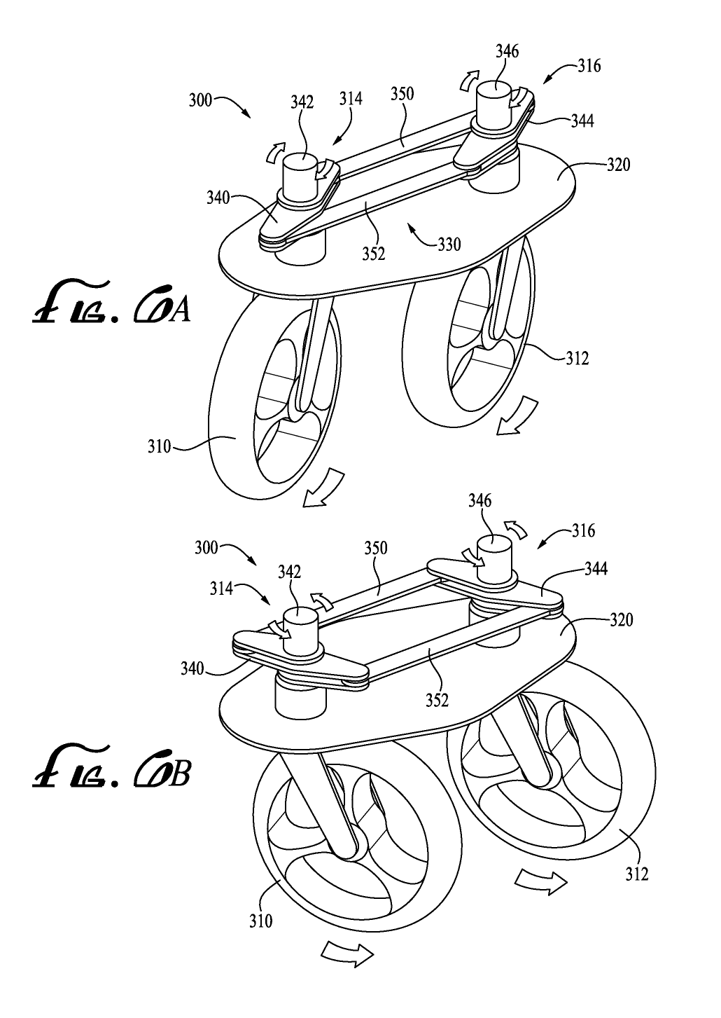

FIGS. 6A and 6B show another example embodiment of a wheel assembly 300 for a stroller or other transport mechanism. The wheel assembly 300 includes a first wheel 310 and a second wheel 312, which are independently pivotally mounted to a support housing or frame member 320 of the transport mechanism by separate pivotal couplings 314, 316. A linkage 330 couples the pivotal rotation or steering of wheels 310, 312 so that they pivotally rotate or swivel in generally synchronized or coordinated motion together with one another and maintain a generally or substantially parallel alignment throughout their range of rotation. FIG. 6A shows the wheels 310, 312 rotated in a first direction, and FIG. 6B shows the wheels rotated in an opposite second direction, as indicated by the directional arrows. The linkage 330 comprises a first crank or yoke 340 extending transversely from a first castor shaft or axle 342 of the first pivotal coupling 314, to which the first wheel 310 is mounted; and a second crank or yoke 344 extending transversely from a second castor shaft or axle 346 of the second pivotal coupling 316, to which the second wheel 312 is mounted. The first and second crank or yoke elements 340, 344 comprise a central flange extending transversely from the castor shafts 342, 346 in opposed first and second directions, an upper flange spaced axially above the central flange and extending transversely from the castor shafts in the first direction, and a lower flange spaced axially below the central flange and extending transversely from the castor shafts in the second direction. A first intermediate link 350 is pivotally mounted as by a pin connection between distal ends of the first and second crank or yoke elements 340, 344 between their upper flanges and central flanges; and a second intermediate link 352 is pivotally mounted as by a pin connection between distal ends of the first and second crank or yoke elements 340, 344 between their lower flanges and central flanges. In this manner, the linkage 330 comprises a four-bar linkage defining a generally parallelogram configuration, with arms 350, 352 being generally parallel to one another and cranks 340, 344 being generally parallel to one another, allowing the wheels 310, 312 to rotate with one another in generally synchronized motion about a full 360° rotation, maintaining the wheels in generally or substantially parallel alignment throughout their rotation.

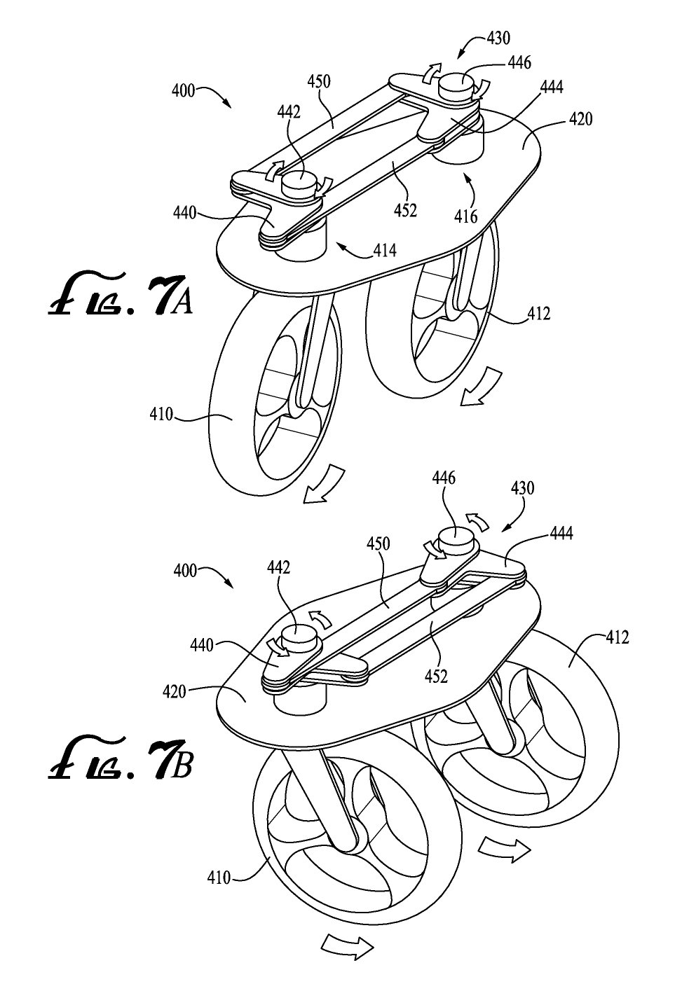

FIGS. 7A and 7B show another example embodiment of a wheel assembly 400 for a stroller or other transport mechanism. The wheel assembly 400 includes a first wheel 410 and a second wheel 412, which are independently pivotally mounted to a support housing or frame member 420 of the transport mechanism by separate pivotal couplings 414, 416. A linkage 430 couples the pivotal rotation of wheels 410, 412 so that they swivel in generally synchronized motion and maintain a generally or substantially parallel alignment throughout their range of rotation. FIG. 7A shows the wheels 410, 412 rotated in a first direction, and FIG. 7B shows the wheels rotated in an opposite second direction, as indicated by the directional arrows. The linkage 430 comprises a first bell-crank or yoke 440 extending transversely from a first castor shaft or axle 442 of the first pivotal coupling 414, to which the first wheel 410 is mounted; and a second bell-crank or yoke 444 extending transversely from a second castor shaft or axle 446 of the second pivotal coupling 416, to which the second wheel 412 is mounted. The bell cranks or yokes 440, 444 each comprise a pair of angularly offset arms connected at a vertex or hub at the first and second pivotal couplings 414, 416, for example a first crank arm oriented at about 90° from a second crank arm. The first and second bell-crank or yoke elements 440, 444 comprise a central flange extending transversely from the castor shafts 442, 446 in generally orthogonal or perpendicular first and second directions, an upper flange spaced axially above the central flange and extending transversely from the castor shafts in the first direction, and a lower flange spaced axially below the central flange and extending transversely from the castor shafts in the second direction. A first intermediate link 450 is pivotally mounted as by a pin connection between distal ends of the first and second crank or yoke elements 440, 444 between their upper flanges and central flanges; and a second intermediate link 452 is pivotally mounted as by a pin connection between distal ends of the first and second crank or yoke elements 440, 444 between their lower flanges and central flanges. In this manner, the linkage 430 comprises a four-bar linkage defining a generally parallelogram configuration, allowing the wheels 410, 412 to rotate in generally synchronized motion about a full 360° rotation, maintaining the wheels in generally or substantially parallel alignment throughout their rotation. The orthogonal offset of the first and second flange directions of this embodiment may provide a smoother rotational motion, and prevent cross-toggling and possible binding of the first and second intermediate links 450, 452 when the linkage aligns at the 90° and 270° positions.

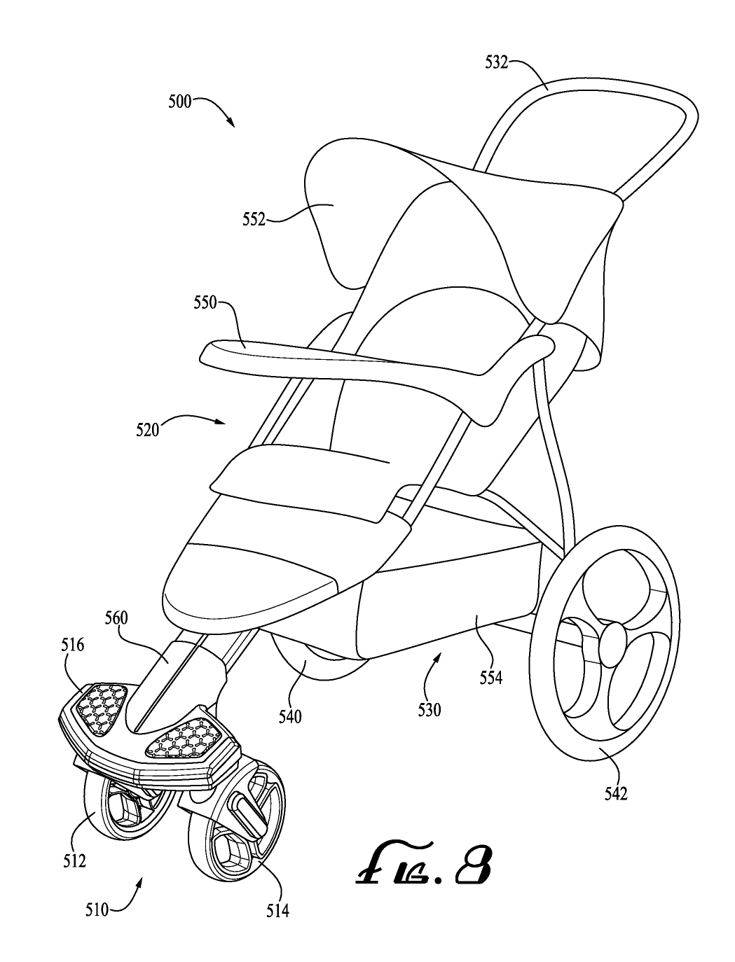

FIG. 8 shows a wheeled transport device in the form of a stroller 500 comprising a wheel assembly 510 having first and second castor wheels 512, 514 according to an example form of the invention. While the wheel assembly of the present invention may be utilized in connection with various stroller configurations or other types of wheeled transport devices, the depicted stroller takes the form of a three-wheeled type of stroller having a seat 520 for a child, a frame 530 comprising a handle 532 extending to the rear of the stroller for pushing by a parent or caregiver, and first and second rear wheels 540, 542 spaced on opposite sides of the seat 520. Optionally accessories such as a tray 550, a canopy 552 and/or a carrier basket 554 are provided. The frame 530 can be rigidly constructed, or alternatively can be foldable and collapsible for more compact storage. The frame further comprises a single front frame member or front leg 560 extending to the front of the stroller 500, to which the wheel assembly 510 is mounted. In alternate four-wheel type strollers, the frame may include two front legs, each having a wheel assembly mounted thereto. In example embodiments, the first and second castor wheels 512, 514 are separately coupled pivotally to a support member 516, each wheel having its own pivot coupling such as a pivot axle and bearing assembly, and spaced from one another by a distance or wheel spacing (see wheel spacing S₁ in FIG. 4) greater than the diameter of the castor wheels and less than the spacing between rear wheels 540, 542. In further example embodiments, the wheel spacing between the pivot couplings of castor wheels 512, 514 of the front wheel assembly 510 is between 0.25-0.75 times the spacing between the rear wheels 540, 542, for example about one-half the spacing between the rear wheels or less. The castor wheels 512, 514 are operatively coupled to one another by a linkage mechanism, for example as described above, to pivotally rotate or swivel in generally synchronized motion with one another, allowing for smoother turning of the stroller 500 and providing improved stability relative to many three-wheeled type strollers having a single front wheel, while being relatively compact and maneuverable as compared to many four-wheeled type strollers.

FIG. 9 shows another example embodiment of a wheel assembly 600 for a stroller or other transport mechanism. The wheel assembly 600 includes a first wheel 610 and a second wheel 612, which are independently pivotally mounted to a support housing or frame member 620 of the transport mechanism by separate pivotal couplings 614, 616. A linkage 630 couples the pivotal rotation of wheels 610, 612 so that they rotate or swivel in generally synchronized motion with one another and maintain a generally parallel alignment throughout their range of rotation. The linkage 630 comprises a first pulley 640 mounted to a first castor shaft or axle 642 extending from the first wheel 610 and rotationally mounted to the housing 620, and a second pulley 644 mounted to a second castor shaft or axle 646 extending from the second wheel 612 and rotationally mounted to the housing. The first and second castor shafts 642, 646 are generally parallel to one another and spaced a horizontal distance from one another corresponding to the wheel-spacing distance of the first and second wheels 610, 612. The linkage 630 further comprises a belt 650 engaged around and between the first and second pulleys 640, 644. The belt 650 is optionally a toothed or synchronous belt having cogs or teeth interengaging with cooperating complementary cogs or teeth within the belt-receiving channel of the pulleys. The linkage 630 causes the first and second wheels 610, 612 to rotate generally in unison or in generally synchronized motion and maintain a generally or substantially parallel or aligned orientation as the wheel assembly 600 turns during operation and steering of the stroller or other transport mechanism to which it is coupled.

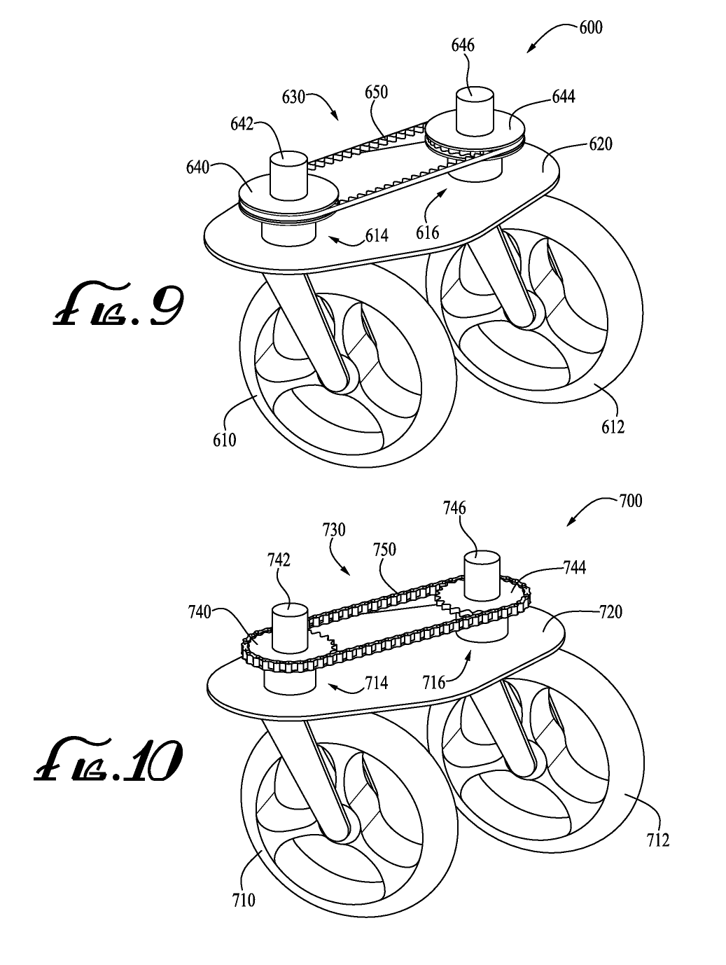

FIG. 10 shows another example embodiment of a wheel assembly 700 for a stroller or other transport mechanism. The wheel assembly 700 includes a first wheel 710 and a second wheel 712, which are independently pivotally mounted to a support housing or frame member 720 of the transport mechanism by separate pivotal couplings 714, 716. A linkage 730 couples the pivotal rotation of wheels 710, 712 so that they rotate or swivel in generally synchronized motion with one another and maintain a generally parallel alignment throughout their range of rotation. The linkage 730 comprises a first sprocket 740 mounted to a first castor shaft or axle 742 extending from the first wheel 710 and rotationally mounted to the housing 720, and a second sprocket 744 mounted to a second castor shaft or axle 746 extending from the second wheel 712 and rotationally mounted to the housing. The first and second castor shafts 742, 746 are generally parallel to one another and spaced a horizontal distance from one another corresponding to the wheel-spacing distance of the first and second wheels 710, 712. The linkage 730 further comprises a chain 750 engaged around and between the first and second sprockets 740, 744. The chain 750 is preferably a drive chain or roller chain having links with spaced rollers or bushings interengaging with cooperating complementary teeth of the sprockets 740, 744. The linkage 730 causes the first and second wheels 710, 712 to rotate generally in unison or in generally synchronized motion and maintain a generally or substantially parallel or aligned orientation as the wheel assembly 700 turns during operation and steering of the stroller or other transport mechanism to which it is coupled.

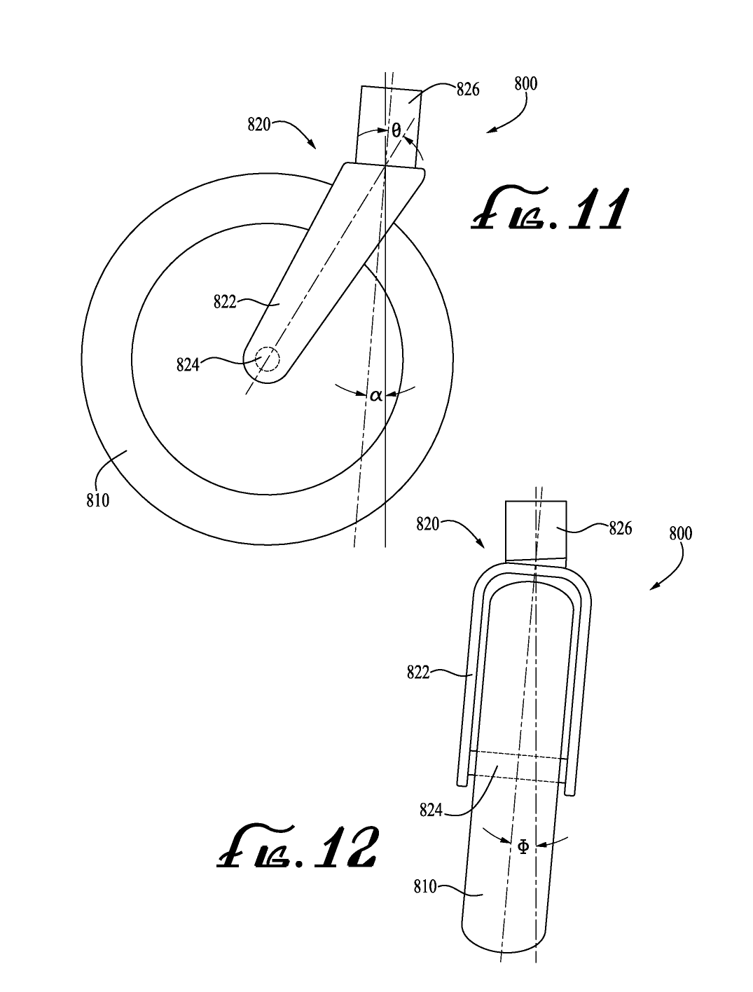

FIGS. 11 and 12 show additional details of a castor wheel assembly 800 according to optional and example forms, which may be adapted for use in connection with the wheel assembly of the present invention. The castor wheel assembly 800 comprises a generally circular wheel 810, for example comprising a rubber or soft plastic outer wheel or tire portion and a hard plastic or metal inner wheel or hub, which may comprise spokes or a disk. The wheel 810 is rotationally mounted to a castor body 820 comprising a yoke or fork 822 to which an axle 824 is mounted. A bearing or bushing may be provided to allow smooth rotation of the wheel 810 about the axle 824. The castor body 820 further comprises an upper strut or castor shaft 826 extending upward from the fork 822, which may be rotationally mounted to a housing or frame member of a transport mechanism.

FIG. 11 shows a castor offset of the wheel assembly 800, which may comprise a castor fork offset angle Θ between the axis of the castor shaft 826 and the longitudinal axis of the castor fork 822, and/or a castor shaft offset angle α between the axis of the castor shaft 826 and vertical. The castor offset may provide smoother control and direction of the wheel during turning by creating a horizontal offset distance with the point of frictional contact between the wheel 810 and the support surface on which it rolls positioned behind the castor shaft in the direction of travel, and further may help prevent wobbling of the wheel as it rolls. The castor fork offset angle Θ may be for example between about 15°-45°, and more preferably about 30°; and the castor shaft offset angle α may be for example between about 0°-5°, and more preferably about 2° or less.

FIG. 12 shows a camber offset of the wheel assembly 800, with a camber angle Φ defined between the medial plane of the wheel 810 and the vertical. The camber angle Φ may be for example between about 0°-10°, and more preferably about 5° or less. The camber may be positive or negative, as desired for particular applications, and may be provided for easier steering, smoother turning, better tracking and wheel alignment, or other performance objectives.

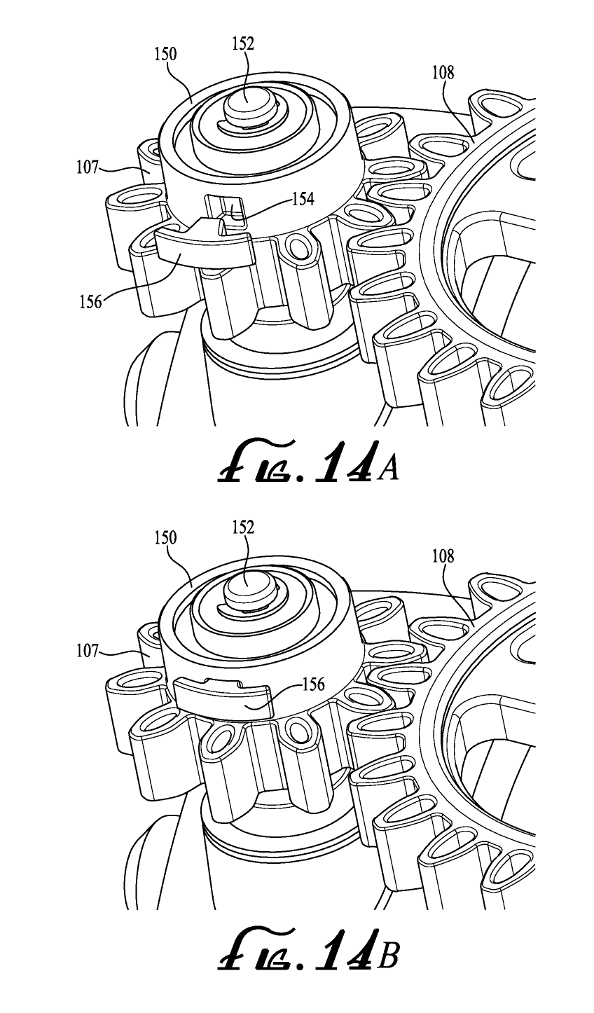

With reference to FIGS. 14A and 14B, in alternative embodiments, one or more stop mechanisms may be provided, operable on the castor shafts and/or on the gears or linkages to releasably lock the caster wheel assemblies in a straight-forward and/or other position and prevent the castors from turning to the left and the right. In this manner the user can selectively actuate the stops or locks to allow steering of the wheels or to provide only forward rolling of the wheels as desired. In the depicted example embodiment, the stop mechanism comprises a hub 150 mounted to rotate with the castor shaft 152 and the first gear 107 as the wheels of the wheeled device turn to the left or right. The hub 150 defines a recess or keyway 154, into which a castor stop or pin 156 can be selectively engaged and disengaged. Engagement of the castor stop or pin 156 into the recess or keyway 154 of the hub 150 locks the position of the caster assembly and prevents turning of the wheels to the left or the right (but still allows rolling rotation of the wheels), whereas disengagement of the castor stop or pin from the recess or keyway frees the castor assembly to turn to the left or the right. The castor stop or pin may be actuated by a lever, a switch, a cable mechanism, or any suitable actuator mechanism, which may be affixed to the frame, housing, or other structural component of the wheeled mechanism. Two or more recesses or keyways may optionally be provided to lock the casters at different positions. In further alternate embodiments, the locking mechanism may operate in connection with any one or more of the gears, linkages, caster shafts or other components to selectively lock or release one or both castor assemblies from turning.

The present invention is susceptible to embodiments in different forms. The specification illustrates preferred embodiments, but is not intended to limit the present invention to the embodiments disclosed. Persons having ordinary skills in the art will appreciate that other embodiments and variations of the invention are possible, which employ the same inventive concepts as described above. Thus, while the invention has been described with reference to preferred and example embodiments, it will be understood by those skilled in the art that a variety of modifications, additions and deletions are within the scope of the invention, as defined by the following claims.

What is claimed is:

1. A wheel assembly for a child support device comprising:
a first wheel coupled to a first swivel mechanism;
a second wheel coupled to a second swivel mechanism; and
a linkage coupling the first swivel mechanism to the second swivel mechanism and configured to allow the first wheel and second wheel to swivel in generally synchronized motion.

2. The wheel assembly of claim 1, wherein the linkage comprises a gear train.

3. The wheel assembly of claim 1, wherein the linkage comprises a belt looped over pulleys.

4. The wheel assembly of claim 1, wherein the linkage comprises a roller chain looped over sprockets.

5. The wheel assembly of claim 1, wherein the linkage comprises a parallel arm linkage.

6. The wheel assembly of claim 1, wherein the first and second wheels are disposed at a non-zero camber angle.

7. The wheel assembly of claim 1, wherein the first and second wheels are sufficiently spaced apart to allow 360-degree swiveling.

8. A wheel assembly comprising:
a first wheel and a second wheel maintained in substantially aligned orientation, the first wheel being coupled to a first swivel mechanism and the second wheel being coupled to a separate second swivel mechanism;
a first gear coupled to the first swivel mechanism;
a second gear coupled to the second swivel mechanism; and
at least one additional gear engaged with first gear and second gear to form a gear train, and wherein the gear ratio between the first gear and the second gear is approximately equal to one.

9. The wheel assembly of claim 8, wherein the first and second wheels are disposed at a non-zero camber angle.

10. The wheel assembly of claim 8, wherein the first wheel and the second wheel are synchronized to swivel in the same direction.

11. The wheel assembly of claim 8, wherein the first wheel and second wheel are sufficiently spaced apart to allow 360-degree pivoting.

12. The wheel assembly of claim 8, wherein the gear train is enclosed in a housing.

13. The wheel assembly of claim 8, wherein the housing further comprises a step or footrest.

14. A wheel assembly for a transport device, the wheel assembly comprising a support member and first and second wheels, wherein the first and second wheels are pivotally mounted to the support member by separate pivotal couplings, and operatively coupled to pivot in generally coordinated motion relative to the support member.

15. The wheel assembly of claim 14, wherein the first and second wheels each define a diameter, and are spaced a distance from one another greater than the diameter.

16. The wheel assembly of claim 14, wherein the first and second wheels are operatively coupled by a linkage comprising a gear train.

17. The wheel assembly of claim 14, wherein the first and second wheels are operatively coupled by a rail and slider linkage.

18. The wheel assembly of claim 14, wherein the first and second wheels are operatively coupled by a parallel arm linkage.

19. The wheel assembly of claim 14, wherein the first and second wheels are operatively coupled by a bell-crank linkage.

20. A wheeled transport device comprising first and second rear wheels and a front wheel assembly, wherein the front wheel assembly comprises a pair of pivotally mounted front wheels operatively coupled to pivot together in unison with one another, each of the front wheels being pivotally mounted to a support member by a separate pivotal coupling.

21. The wheeled transport device of claim 20, comprising a stroller.

22. The wheeled transport device of claim 21, wherein the stroller comprises a three-wheeled type stroller comprising a frame having a single front leg.

23. The wheeled transport device of claim 20, wherein the pair of pivotally mounted front wheels each define a diameter, and wherein the pivotal couplings are spaced a distance greater than the diameter of the front wheels.

24. The wheeled transport device of claim 23, wherein the first and second rear wheels define a rear wheel spacing therebetween, and wherein the spacing distance between the pivotal couplings of the front wheels is less than the rear wheel spacing.

25. The wheeled transport device of claim 24, wherein the spacing distance between the pivotal couplings of the front wheels is between 0.25-0.75 times the rear wheel spacing.

26. The wheeled transport device of claim 24, wherein the spacing distance between the pivotal couplings of the front wheels is about one-half the rear wheel spacing.

27. The wheeled transport device of claim 20, further comprising at least one releasable stop mechanism operable to selectively prevent and allow pivoting of the front wheels.
